(19) United States
(12) Patent Application Publication
(10) Pub. No.: US 2011/0262633 A1
(43) Pub. Date: Oct. 27, 2011

(54) LUBRICANT DEPOSITION ONTO MAGNETIC MEDIA

(75) Inventors: Jiping Yang, San Jose, CA (US); Michael J. Stirniman, Fremont, CA (US); Xiaoding Ma, Fremont, CA (US); Yiao-Tee Hsia, Pleasanton, CA (US)

(73) Assignee: SEAGATE TECHNOLOGY LLC, Scotts Valley, CA (US)

(21) Appl. No.: 12/768,570

(22) Filed: Apr. 27, 2010

(51) Int. Cl. B05D 5/12; B05C 11/00

(52) U.S. Cl. 427/127; 118/600

(57) ABSTRACT

A method, in one embodiment, can include pumping a gas into a reservoir that includes a lubricant. In addition, the method can include changing the gas into a supercritical fluid that extracts lubricant molecules from the lubricant resulting in a mixture of the supercritical fluid and the lubricant molecules. Furthermore, the method can include utilizing the mixture to deposit a lubricant molecule onto a magnetic media.

### BACKGROUND

In the hard disk drive industry, there are generally two ways to coat lubricant onto a magnetic recording disk: a dip-coating process and a thermal vapor phase lubrication process. In the dip-coating process, post sputtered disks, held by a mandrel, are immersed in a lubricant solution, and then lifted from the solution. The lubricant thickness can be controlled by controlling the lubricant concentration and lifting speed of the disk. However, there are some disadvantages associated with this process. For example, it involves using a large amount of expensive and volatile fluorinated solvent, which adversely adds to the cost of the process and also causes environmental issues.

The thermal vapor phase lubrication process involves thermal vaporization of a perfluoropolyether (PFPE) lubricant in a vacuum, followed by condensation of the lubricant vapor onto a room temperature thin film magnetic disk. However, one drawback of this technique is that the PFPE lubricants supplied to the data storage industry are not pure, but rather are mixtures consisting of a distribution of molecular weights. Each molecular weight component of the mixture has a different vapor pressure, and as a result, the mixture is fractionated by molecular weight as the deposition process progresses. As such, disks processed at different times of the process have a different average molecular weight of lubricant deposited, with lighter materials on disks near the beginning of the process and heavier materials on disks later. The cycle of light material to heavier material repeats itself each time the liquid lubricant is recharged into the evaporator. A second drawback is that deposition of lubricant films containing two or more different chemical components will involve a separate evaporation process station for each component. A third drawback is the use of high temperatures for extended periods of time, which may lead to thermal degradation of the PFPE material.

### SUMMARY

A method, in one embodiment, can include pumping a gas into a reservoir that includes a lubricant. In addition, the method can include changing the gas into a supercritical fluid that extracts lubricant molecules from the lubricant resulting in a mixture of the supercritical fluid and the lubricant molecules. Furthermore, the method can include utilizing the mixture to deposit a lubricant molecule onto a magnetic media.

In another embodiment, a system can include a nozzle and a reservoir coupled to the nozzle and for holding a lubricant. Additionally, the system can include a compressor for pumping a gas into the reservoir and for controlling an internal pressure of the reservoir. Moreover, the system can include a heater for changing the temperature of the reservoir. Note that the compressor and the heater can be for converting the gas into a supercritical fluid within the reservoir that extracts lubricant molecules from the lubricant resulting in a mixture of the supercritical fluid and the lubricant molecules. In addition, the nozzle can be for outputting the mixture towards a magnetic media.

In yet another embodiment, a method can include pumping a gas into a reservoir that includes a plurality of lubricants. The method can also include altering the gas into a supercritical fluid that extracts lubricant molecules from the plurality of lubricants resulting in a mixture of the supercritical fluid and the lubricant molecules. Furthermore, the method can include outputting the mixture from the reservoir to deposit lubricants onto a magnetic disk.

While particular embodiments in accordance with the invention have been specifically described within this Summary, it is noted that the invention and the claimed subject matter are not limited in any way by these embodiments.

### BRIEF DESCRIPTION OF THE DRAWINGS

FIG. 1 is a block diagram of a hard disk drive fabrication system in accordance with various embodiments of the invention.

FIG. 2 is a block diagram of a lubricant deposition system in accordance with various embodiments of the invention.

FIG. 3 is a block diagram of another lubricant deposition system in accordance with various embodiments of the invention.

FIG. 4 is a flow diagram of a method in accordance with various embodiments of the invention.

The drawings referred to in this description should not be understood as being drawn to scale except if specifically noted.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

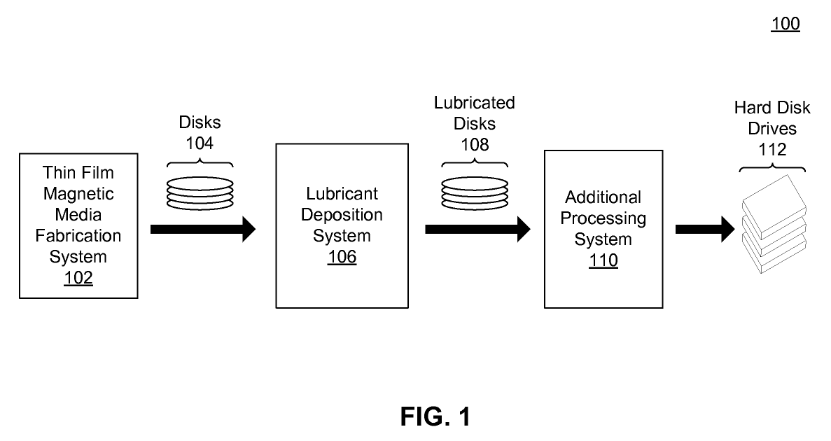

FIG. 1 is a block diagram of a hard disk drive fabrication system 100 in accordance with various embodiments of the invention. For example, the hard disk drive fabrication system 100 can include, but is not limited to, a thin film magnetic media fabrication system 102, a lubricant deposition system 106, and an additional processing system 110. As such, the hard disk drive fabrication system 100 can produce hard disk drives 112 that each include one or more lubricated thin film magnetic media 108.

Specifically, within the thin film magnetic disk fabrication system 102, one or more thin film magnetic media or disks (e.g., 104) can be fabricated which can be eventually incorporated into one or more hard disk drives. It is noted that the one or more thin film magnetic media or disks 104 can be fabricated in a wide variety of ways. For example in one embodiment, the one or more thin film magnetic media 104 can be implemented to include, but not limited to, a tribological coating that includes a layer of thin amorphous carbon.

Within FIG. 1, once the one or more thin film magnetic media or disks 104 have been fabricated, one or more of them can be loaded or inserted into the lubricant deposition system 106. Once loaded, one or more lubricants can be deposited onto the one or more exposed surfaces of the thin film magnetic media 104 using a supercritical fluid deposition process in accordance with various embodiments of the invention. In one embodiment, the one or more lubricants are deposited onto the thin film magnetic media 104 to prevent corrosion and to protect it from being damage if a hard disk drive head comes into contact with it. Note that specific operations of the lubricant deposition system 106 in accordance with various embodiments are described herein, but are not limited to such. It is pointed out that the one or more lubricants utilized within the lubricant deposition system 106 can be implemented in a wide variety of ways. For example in various embodiments, the one or more lubricants can include, but are not limited to, one or more different types of perfluoropolyether (PFPE). In one embodiment, a tetrahydroxy perfluoropolyether, which may be found under the product name of Fomblin® Z Tetraol®, can be the lubricant utilized within the lubricant deposition system 106, but is not limited to such.

Once the lubricant deposition system 106 produces the one or more lubricated media or disks 108, they can be loaded or inserted into the additional processing system 110. Note that a wide variety of activities can be performed on the one or more lubricated thin film magnetic media 108 by the additional processing system 110. For example in various embodiments, the activities of the additional processing system 110 can include, but is not limited to, a final polishing operation of the one or more lubricated thin film magnetic media 108 (which may be referred to as “tape buff/wipe”), testing the one or more lubricated thin film magnetic media 108 to determine if each will support fly height and to detect any defects, and/or incorporating the one or more lubricated thin film magnetic media 108 into one or more hard disk drives 112. In this manner, the additional processing system 110 can produce one or more hard disk drives 112 that each include one or more lubricated thin film magnetic media or disks 108.

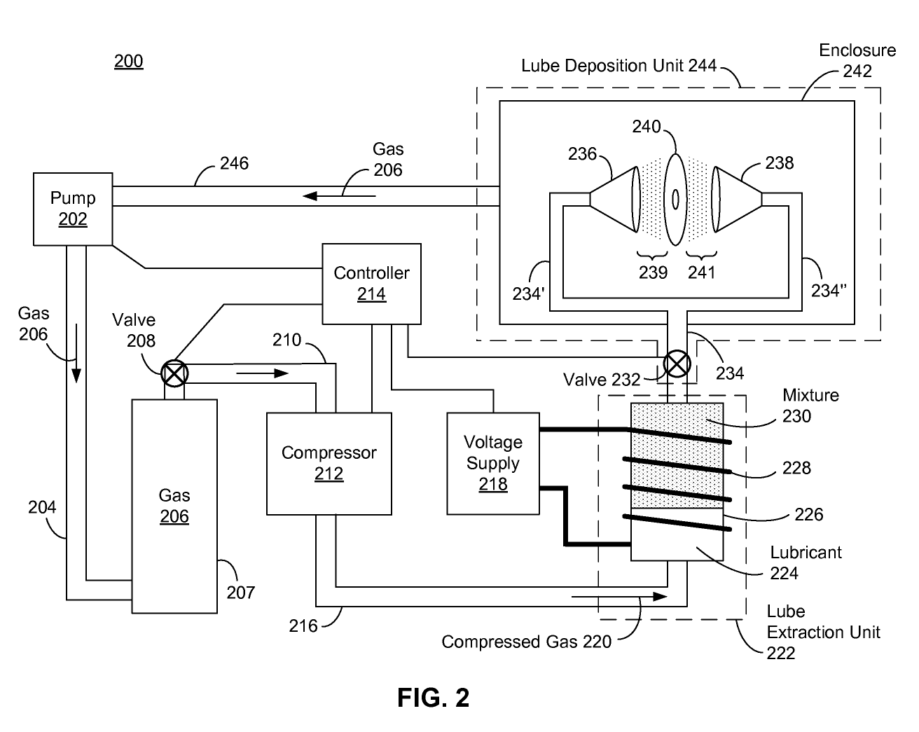

FIG. 2 is a block diagram of a lubricant deposition system 200 in accordance with various embodiments of the invention. It is pointed out that in an embodiment, the lubricant deposition system 200 can be an implementation of the lubricant deposition system 106 (FIG. 1), but is not limited to such. Within FIG. 2, a thin film magnetic media or disk 240 (similar to media 104) can be loaded or inserted into an enclosure 242 of the system 200 for a temporary amount of time so that a lubricant deposition process in accordance with an embodiment of the invention can deposit one or more lubricants 224 onto one or more of its exposed surfaces. It is noted that in one embodiment, the one or more lubricants 224 can be deposited onto the thin film magnetic media 240 to improve its resistance to corrosion and to protect or guard it from being worn when a head of a hard disk drive comes into contact with it. After which, the thin film magnetic disk 240 including deposited lubricant can be unloaded or removed from the enclosure 242. Subsequently, the thin film magnetic disk 240 including deposited lubricant may be eventually incorporated as a component of a hard disk drive (e.g., 112).

In one embodiment, the lubricant deposition system 200 can implement a supercritical fluid lubrication process in order to deposit one or more lubricants 224 onto the thin film magnetic disk 240. For example in an embodiment, a compressed gas 220 within the lubricant deposition system 200 can be converted into a supercritical fluid that essentially acts as a solvent for the one or more lubricants 224 stored within the lubricant vessel 226. As such, a mixture 230 can be created or generated that includes the supercritical fluid of gas 220 together with molecules of the one or more lubricants 224. Therefore, the supercritical fluid of gas 220 can act as a carrier and a depositor of the one or more lubricants 224, which can be deposited onto the thin film magnetic disk 240. In one embodiment, a supercritical fluid is a substance located between a gas state and a liquid state, thereby including the properties of both the gas and liquid states. A substance can be changed or converted into a supercritical fluid when its temperature and pressure are elevated beyond its thermodynamic critical point. Note that the thermodynamic critical point of a substance can be defined as the combined minimum temperature and minimum pressure at which the substance exhibits both the properties of a gas and a liquid. It is pointed out that a supercritical fluid is able to pass through materials in a manner similar to a gas. At the same time, the supercritical fluid is able to function as a solvent in a manner similar to a liquid.

Within FIG. 2, the lubricant deposition system 200 in one embodiment can include, but is not limited to, a pump 202, a gas reservoir 207 which can store one or more gases 206, a compressor 212, a controller or computing device 214, a voltage supply 218, a heater 228, capillary valves 208 and 232, a reservoir or vessel 226 which can store one or more lubricants 224 along with the mixture 230, vapor shape control devices (or nozzles) 236 and 238, a lubricant deposition enclosure 242, and capillaries 204, 210, 216, 234, 234′, 234″, and 246. It is pointed out that in an embodiment, the lubricant deposition system 200 does not include the deposition enclosure 242.

The lubricant reservoir 226 of the lubricant deposition system 200 can contain or hold the one or more lubricants 224. It is noted that the one or more lubricants 224 can be implemented in a wide variety of ways. For example in various embodiments, the one or more lubricants 224 can include, but are not limited to, one or more different types of perfluoropolyether (PFPE). In one embodiment, a tetrahydroxy perfluoropolyether, which may be found under the product name of Fomblin® Z Tetraol® (at different molecular weights), can be the lubricant 224, but is not limited to such. In various embodiments, the one or more lubricants 224 can include, but are not limited to, Fomblin® Z-Dol (at different molecular weights), A20H™ (at different molecular weights) by Matsumura Oil Research Corporation (MORESCO), and the like. It is pointed out that the gas reservoir (or vessel or cylinder) 207 can store or hold the one or more gases 206. Note that the one or more gases 206 can be implemented in a wide variety of ways. For example, the one or more gases 206 can be implemented using a gas and/or a liquid such as, but not limited to, carbon dioxide (CO₂), methane (CH₄), ethane (C₂H₆), ethylene (C₂H₄), water (H₂O), methanol (CH₃OH), ethanol (C₂H₅OH), acetone (C₃H₆O), propane (C₃H₈), and propylene (C₃H₆). In one embodiment, to improve extraction efficiency of the one or more lubricants 224, additives can be added into the extraction gas 206. For example in an embodiment, a secondary gas/fluid can be added to the primary gas/fluid 206. The secondary gas/fluid or additive can include, but is not limited to, carbon dioxide, methane, ethane, ethylene, water, methanol, ethanol, acetone, propane, and propylene.

Within FIG. 2, the lubricant deposition system 200 (in one embodiment) can include, but is not limited to, a lubricant extraction unit 222 and a lubricant deposition unit 244. For example in an embodiment, the lubricant extraction unit 222 can include, but is not limited to, the lubricant vessel 226 for storing one or more lubricants 224, and the heater unit or coil 228 for heating the lubricant vessel 226 along with its contents to a certain temperature. Note that the lubricant extraction unit 222 can also include a capillary 216 for receiving the compressed gas 220 from the compressor 212, wherein the capillary 216 can be coupled to an input or inlet of the lubricant vessel 226. In this manner, the compressed gas 220 can be pumped by the compressor 212 into the lubricant vessel 226 where it can be mixed with the one or more lubricants 224 stored therein. In one embodiment, to improve extraction efficiency of the one or more lubricants 224, one or more additives can be added to the extraction gas 206 before it is compressed by the compressor 212.

Furthermore in an embodiment, the lubricant deposition unit 244 can include, but is not limited to, the capillary valve 232, the deposition enclosure 242, the vapor shape control devices 236 and 238, and the capillaries 234, 234′, and 234″. It is noted that the capillary valve 232 can control the volume or amount of lubricant 224 to be deposited onto the magnetic disk 240 via the vapor shape control devices 236 and 238. In addition, each of the vapor shape control devices 236 and 238 can generate a cone shaped plume of aerosol 239 and 241, respectively, which includes the one or more lubricants 224. In one embodiment, the pressure within the lubricant deposition unit 244 (or its enclosure 242) can be different (e.g., higher or lower) from the pressure within the lubricant vessel 226 of the lubricant extraction unit 222, thereby enabling the mixture 230 that includes the supercritical fluid of gas 220 and molecules of lubricant 224 to flow or spray onto the thin film magnetic disk 240. It is pointed out that the pressure difference between the lubricant vessel 226 and the deposition enclosure 242 (or deposition area without enclosure 242) can make a difference in the quality of the deposition of the one or more lubricants 224 onto the thin film magnetic media 240. For example in an embodiment, if there is a large pressure difference between the lubricant vessel 226 and the deposition enclosure 242 (or deposition area without enclosure 242), the resulting lubricant aerosols 239 and 241 may be more forceful and may include larger droplets of the one or more lubricants 224.

Within FIG. 2, the thin film magnetic media or disk 240 can be loaded or inserted into the vapor deposition enclosure 242. Note that the thin film magnetic media or disk 240 can be positioned in a wide variety of ways during the lubricant deposition process. For example in one embodiment, the thin film magnetic media 240 can be positioned in a substantially vertical manner (as shown), which can aid in the uniform deposition of the one or more lubricants 224 onto the thin film magnetic media 240. In addition, it is noted that a wide variety of pressures can exist within the vapor deposition enclosure 242. For example, the pressure within the vapor deposition enclosure 242 can be greater than, less than, or substantially similar to the pressure within the lubricant reservoir 226, but is not limited to such. Furthermore, an ambient pressure or sub-ambient pressure can exist within the vapor deposition enclosure 242, but is not limited to such. Note that in one embodiment, ambient pressure can signify that no special effort was made to control pressure within the vapor deposition enclosure 242 (e.g., the deposition enclosure 242 may not be sealed), but is not limited to such. In addition, in an embodiment, once the vapor deposition enclosure 242 is sealed, a vacuum can be created within it (e.g., approximately 1×10⁻⁶ Torr, but not limited to such). As previously mentioned above, a supercritical fluid lubrication process in accordance with an embodiment of the invention can be utilized to deposit one or more lubricants 224 onto one or more surfaces of the thin film magnetic media 240.

For example in one embodiment, one or more lubricants 224 can be put into the lubricant reservoir 226. It is pointed out that the temperature and the pressure of the lubricant reservoir or vessel 226 can be controlled via the compressor unit 212 and the heater unit 228. In this manner, different components of the one or more lubricants 224 can be extracted from the vessel 226 or all of the components of the one or more lubricants 224 can be extracted from the vessel 226. As previously mentioned above, when the compressed gas 220 is a supercritical fluid, it is between a gas state and a liquid state. Accordingly, by adjusting the temperature and/or pressure of the supercritical fluid of gas 220, the density of the supercritical fluid of gas 220 can be gradually changed to be more closely to a liquid or more closely to a gas. In this fashion, the density can be regulated of the supercritical fluid of gas 220. Moreover, it is noted that by changing the density of the supercritical fluid of gas 220, the property of the supercritical fluid of gas 220 can be changed. For example in an embodiment, if the density of the supercritical fluid of gas 220 is altered to be closer to a gas, then the supercritical fluid of gas 220 can have more energy to penetrate the one or more lubricants 224 within the lubricant vessel 226. In one embodiment, if the density of the supercritical fluid of gas 220 is modified to be closer to a liquid, then the supercritical fluid of gas 220 can have more power to extract molecules from the one or more lubricants 224 within the lubricant vessel 226.

Within FIG. 2, in preparation of the lubricant reservoir 226 receiving the compressed gas 220 in an embodiment, it can be heated to a certain temperature by the heater unit 228. It is noted that the heater unit 228 in the present embodiment can be coupled to and controlled by the voltage supply 218, which can be coupled to and controlled by the controller 214. Additionally, since the gas 206 can be stored under pressure within the vessel 207, when the controller 214 opens the capillary valve 208, the gas 206 can travel or traverse out of the gas vessel 207, through the capillary valve 208, and through the capillary 210 to be received by or input into the compressor unit 212. Furthermore, it is pointed out that the controller 214 can be coupled to and controls the operation of the compressor 212, thereby enabling the controller 214 to set or establish the desired pressure of the received gas 206. As such, the compressor 212 can compress or pressurize the received gas 206, which it can output as the compressed gas 220 via the capillary 216. Since the lubricant reservoir 226 is coupled to the capillary 216 in the present embodiment, the lubricant reservoir 226 can receive the compressed gas 220 that was (and may continue to be) pumped into the capillary 216 by the compressor 212.

After the compressed gas 220 is received by the lubricant reservoir 226 of FIG. 2, the compressed gas 220 can be converted or changed into a supercritical fluid. For example in one embodiment, while the capillary valve 232 is closed, the lubricant reservoir 226 along with the one or more lubricants 224 stored therein can be preheated to a temperature above the thermodynamic critical point of the compressed gas 220. Moreover, the compressor 212 can compress or pressurize the compressed gas 220 to a pressure beyond its thermodynamic critical point. As such, after the compressed gas 220 is received by the lubricant reservoir 226, the compressed gas 220 can be heated and pressurized above its thermodynamic critical point, at which time the compressed gas 220 can be altered into a supercritical fluid which can in essence act like a solvent for the one or more lubricants 224 stored within the lubricant reservoir 226. Consequently, the supercritical fluid of gas 220 can extract molecules from the one or more lubricants 224 thereby resulting in the generation of the mixture 230 within the lubricant reservoir 226.

It is noted that in one embodiment, the capillary valve 232 can be coupled to and controlled by the controller 214. Accordingly, once the mixture 230 has been generated, the controller 214 can cause the value 232 to open thereby enabling the mixture 230 to be released from the lubricant reservoir 226 via the capillary 234. As such, the mixture 230 can travel through capillaries 234, 234′, and 234″ to be output by the vapor shape control devices 236 and 238. Note that once the mixture 230 is output from the vapor shape control devices 236 and 238, the supercritical fluid of gas 220 can evaporate from the mixture 230 resulting in lubricant aerosols 239 and 241 that include the one or more lubricants 224. Therefore, the output spray or flow of the lubricant aerosols 239 and 241 can result in the deposition of the one or more lubricants 224 onto one or more surfaces of the thin film magnetic media or disk 240. In an embodiment, the lubricant aerosols 239 and 241 can travel in an essentially line-of-sight path to the magnetic media 240 and condense on its surfaces. It is pointed out that the supercritical fluid of gas 220 evaporates from the mixture 230 when output from the vapor shape control devices 236 and 238 since the supercritical fluid of gas 220 is no longer being compressed or heated. Consequently, the supercritical fluid of gas 220 can revert back to being gas 206.

Within FIG. 2, it is pointed out that the lubricant deposition system 200 can include a system for recovering the gas 206 that remains within the vapor deposition enclosure 242 during or after the mixture 230 is output from the vapor shape control devices 236 and 238. For example in an embodiment, the vapor deposition enclosure 242 can be coupled to the pump 202 via the gas capillary 246, thereby enabling the pump 202 to remove the remaining gas 206 from the vapor deposition enclosure 242. Furthermore, the pump 202 can be coupled to the gas reservoir (or vessel or cylinder) 207 via the gas capillary 204, thereby enabling the pump 202 to add the recovered gas 206 into the gas reservoir 207. In this manner, the recovered gas 206 can be reused within the lubricant deposition system 200. In one embodiment, the pump 202 can be coupled to and controlled by the controller 214. Accordingly, the controller 214 can control the operation (or functionality) of the pump 202.

It is noted that each of the vapor shape control devices (or nozzles) 236 and 238 can be implemented in a wide variety of ways. For example, each of the vapor shape control devices (or nozzles) 236 and 238 can be implemented with, but is not limited to, a funnel or conical shaped device (as shown), any type of aerosol nozzle, and any type of spray nozzle. In one embodiment, the vapor shape control device 236 can be implemented in a manner different than the vapor shape control device 238, and vice versa. In addition, in an embodiment, the vapor shape control device 236 can be implemented in a manner similar to the vapor shape control device 238, and vice versa.

Within FIG. 2, it is noted that each of the capillary valves 208 and 232 can be implemented in a wide variety of ways. For example in one embodiment, each of the capillary valves 208 and 232 can be implemented with, but is not limited to, a pulsed solenoid valve that pulses on and off. Note that in an embodiment, the deposition of the one or more lubricants 224 onto the one or more surfaces of the thin film magnetic media or disk 240 via the lubricant aerosols 239 and 241 can be controlled by the capillary valve 232 instead of by the amount of time the magnetic media 240 is in and out of the deposition system. Accordingly, the capillary valve 232 of the lubricant deposition system 200 can be utilized to control the lubricant deposition as opposed to strictly time. The capillary valves 208 and 232 can each be coupled to a controller (or computing device) 214 which can independently control the operation of each of them. For example in one embodiment, the controller 214 can separately transmit an electrical signal (e.g., 3 volts signal) to each of the capillary valves 208 and 232 which causes each to open or close.

In one embodiment, the controller 214 can be electrically coupled to the pump 202, the compressor 212, the voltage supply 218 coupled to the heater 228, and the capillary valves 208 and 232. In this manner, the controller 214 can independently control the operations of the pump 202, the compressor 212, the heater 228 via its voltage supply 218, and the capillary valves 208 and 232. It is noted that the functionality and/or operations of the controller 214 can be controlled or managed by software, by firmware, by hardware or by any combination thereof, but is not limited to such. Moreover in an embodiment, the controller 214 can be part of a user interface for the lubricant deposition system 200.

Note that experiments in accordance with various embodiments of the invention have been performed with a lubricant deposition system similar to the lubricant deposition system 200 of FIG. 2. For example in one experiment in accordance with an embodiment, 2 grams of Fomblin® Z-Dol 2000 were added to a stainless steel extractor vessel (e.g., reservoir 226). The extractor vessel (e.g., 226) was heated to 45° Celsius (C) and compressed carbon dioxide gas (e.g., 220) was introduced into the extractor vessel (e.g., 226). While the pressure in the extractor vessel (e.g., 226) reached 100 bars, the valve (e.g., 232) was opened. It is noted that given these conditions within the extractor vessel (e.g., 226) and before the valve (e.g., 232) was opened, a mixture (e.g., 230) had been generated within the extractor vessel (e.g., 226) that include a supercritical fluid of carbon dioxide (e.g., 220) along with molecules of the lubricant (e.g., 224). Consequently, once the valve (e.g., 232) was opened, the lubricant (e.g., 224) was deposited onto one or more surfaces of the magnetic media (e.g., 240). Utilizing the Fourier transform infrared (FTIR) calculation, the average lubricant thickness on the surface of the magnetic disk (e.g., 240) was about 12 angstroms (A) or 1.2 nanometers (nm).

In another experiment in accordance with one embodiment of the invention, 1 gram of Fomblin® Z Tetraol® 2000 and 1 gram of A20H™ 2000 were added to a stainless steel extractor vessel (e.g., reservoir 226). The extractor vessel (e.g., 226) was heated to 45° C. and compressed carbon dioxide gas (e.g., 220) was introduced to the extractor vessel (e.g., 226). While the pressure in the extractor vessel (e.g., 226) reached 125 bars, the valve (e.g., 232) was opened. It is pointed out that given these conditions within the extractor vessel (e.g., 226) and before the valve (e.g., 232) was opened, a mixture (e.g., 230) had been generated within the extractor vessel (e.g., 226) that include a supercritical fluid of carbon dioxide (e.g., 220) along with molecules of both of the lubricants (e.g., 224). Accordingly, once the valve (e.g., 232) was opened, the lubricants (e.g., 224) were deposited onto one or more surfaces of the magnetic media (e.g., 240). Utilizing the Fourier transform infrared (FTIR) calculation, the total thickness of the lubricants (e.g., 224) on the surface of the magnetic disk (e.g., 240) was about 21.1 A or 2.11 nm. In addition, the FTIR calculation showed that the lubricant layer contained 19.4 A (or 1.94 nm) of A20H-2000 and 1.7 A (or 0.17 nm) of Z Tetraol 2000.

The lubricant deposition system 200 can be modified in a wide variety of ways. For example in one embodiment, the lubricant deposition system 200 can be altered such that multiple compressed gases (e.g., 220) can be pumped into the lubricant reservoir 226. In an embodiment, the lubricant deposition system 200 can be changed so that the vapor shape control devices (or nozzles) 236 and 238 can each be coupled to a separate lubricant reservoir similar to the lubricant reservoir 226.

Within FIG. 2, the lubricant deposition system 200 can include, but is not limited to, the pump 202, the gas reservoir 207, the compressor 212, the controller 214, the voltage supply 218, the heater 228, the lubricant vessel 226, the valves 208 and 232, the capillaries 204, 210, 216, 234, 234′, 234″, and 246, the vapor shape control devices (or nozzles) 236 and 238, and the deposition enclosure 242. Specifically in an embodiment, an output of the pump 202 can be coupled to an input of the gas reservoir 207 via the capillary 204. An output of the gas reservoir 207 can be coupled to an input of the compressor 212 via the capillary 210 and the capillary valve 208. An output of the compressor 212 can be coupled to an input of the lubricant reservoir 226 via the capillary 216. An output of the lubricant reservoir 226 can be coupled to the vapor shape control devices (or nozzles) 236 and 238 via the capillaries 234, 234′, and 234″ and the capillary valve 232. An output of the deposition enclosure 242 can be coupled to an input of the pump 202 via the capillary 246. The controller 214 can be coupled to control the pump 202, the capillary valves 208 and 232, the compressor 212, and the voltage supply 218 which controls the heater 228.

It is noted that the lubricant deposition system 200 may not include all of the elements illustrated by FIG. 2. Additionally, the lubricant deposition system 200 can be implemented to include one or more elements not illustrated by FIG. 2. It is pointed out that the lubricant deposition system 200 can be utilized or implemented in any manner similar to that described herein, but is not limited to such.

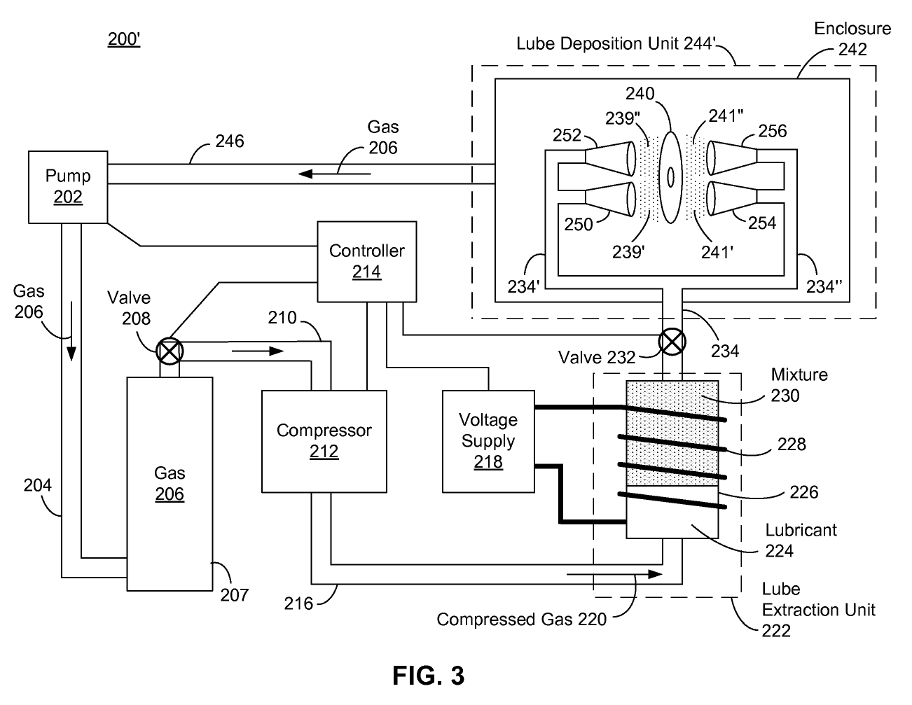

FIG. 3 is a block diagram of a lubricant deposition system 200′ in accordance with various embodiments of the invention which includes an array of vapor shape control devices (or nozzles) 250, 252, 254, and 256. It is pointed out that the elements of FIG. 3 having the same reference numbers as the elements of any other figure herein can operate or function in any manner similar to that described herein, but are not limited to such. Note that in one embodiment, the lubricant deposition system 200′ can be an implementation of the lubricant vapor deposition system 106 (FIG. 1), but is not limited to such.

Specifically in one embodiment, the lubricant deposition system 200′ can include an array or multiple vapor shape control devices or nozzles (e.g., 250, 252, 254, and 256) that can be utilized for depositing one or more lubricants (e.g., 224) onto each surface of the thin film magnetic media 240 to further improve lubricant deposition uniformity, but is not limited to such. It is understood that the lubricant deposition system 200′ of FIG. 3 can function and operate in a manner similar to the lubricant deposition system 200 of FIG. 2, but is not limited to such. It is pointed out that in one embodiment, the lubricant deposition system 200′ of FIG. 3 does not include the enclosure 242.

Within FIG. 3, the lubricant deposition system 200′ can implement a supercritical fluid lubrication process in order to deposit one or more lubricants 224 onto the thin film magnetic disk 240. For example in one embodiment, within the lubricant deposition system 200′, a compressed gas 220 can be converted into a supercritical fluid that in essence acts as a solvent for the one or more lubricants 224 stored within the lubricant vessel 226. Consequently, a mixture 230 can be created or generated that includes the supercritical fluid of gas 220 together with molecules of the one or more lubricants 224. As such, the supercritical fluid of gas 220 can act as a carrier and a depositor of the one or more lubricants 224, which are to be deposited onto the thin film magnetic disk 240 via the array of vapor shape control devices (or nozzles) 250, 252, 254, and 256.

In one embodiment, the lubricant deposition system 200′ can include, but is not limited to, a lubricant extraction unit 222 and a lubricant deposition unit 244′. For example in an embodiment, the lubricant extraction unit 222 can include, but is not limited to, the lubricant vessel 226 for storing one or more lubricants 224, and the heater unit or coil 228 for heating the lubricant vessel 226 along with its contents to a certain temperature. It is noted that the lubricant extraction unit 222 can also include the capillary 216 for receiving the compressed gas 220 from the compressor 212, wherein the capillary 216 can be coupled to an input or inlet of the lubricant vessel 226. In this fashion, the compressed gas 220 can be pumped by the compressor 212 into the lubricant vessel 226 where it can be mixed with the one or more lubricants 224 stored therein. In an embodiment, to improve extraction efficiency of the one or more lubricants 224, one or more additives can be added to the extraction gas 206 before it is compressed by the compressor 212.

Additionally in one embodiment, the lubricant deposition unit 244′ can include, but is not limited to, the capillary valve 232, the deposition enclosure 242, the vapor shape control devices (or nozzles) 250, 252, 254, and 256, and the capillaries 234, 234′, and 234″. Note that the capillary valve 232 can control the volume or amount of lubricant 224 to be deposited onto the magnetic disk 240 via the vapor shape control devices 250, 252, 254, and 256. Furthermore, each of the vapor shape control devices 250, 252, 254, and 256 can generate a cone shaped plume of aerosol 239′, 239″, 241′, and 241″, respectively, which includes the one or more lubricants 224. In one embodiment, the pressure within the lubricant deposition unit 244 (or its enclosure 242) can be different (e.g., higher or lower) from the pressure within the lubricant vessel 226 of the lubricant extraction unit 222, thereby enabling the mixture 230 that includes the supercritical fluid of gas 220 and molecules of lubricant 224 to flow or spray onto the thin film magnetic disk 240. It is noted that the pressure difference between the lubricant vessel 226 and the deposition enclosure 242 (or deposition area without enclosure 242) can make a difference in the quality of the deposition of the one or more lubricants 224 onto the thin film magnetic media 240. For example in one embodiment, if there is a large pressure difference between the lubricant vessel 226 and the deposition enclosure 242 (or deposition area without enclosure 242), the resulting lubricant aerosols 239′, 239″, 241′, and 241″ may be more forceful and may include larger droplets of the one or more lubricants 224.

Within FIG. 3, in one embodiment the capillary valve 232 can be coupled to and controlled by the controller 214. As such, once the mixture 230 has been generated in a manner described herein, the controller 214 can cause the value 232 to open thereby enabling the mixture 230 to be released from the lubricant reservoir 226 via the capillary 234. Consequently, the mixture 230 can travel through capillaries 234, 234′, and 234″ to be output by the vapor shape control devices (or nozzles) 250, 252, 254, and 256. It is noted that that once the mixture 230 is output from the vapor shape control devices 250, 252, 254, and 256, the supercritical fluid of gas 220 can evaporate from the mixture 230 resulting in lubricant aerosols 239′, 239″, 241′, and 241″ that include the one or more lubricants 224. As such, the output spray or flow of the lubricant aerosols 239′, 239″, 241′, and 241″ can result in the deposition of the one or more lubricants 224 onto one or more surfaces of the thin film magnetic media or disk 240. In one embodiment, the lubricant aerosols 239′, 239″, 241′, and 241″ can travel in an essentially line-of-sight path to the magnetic media 240 and condense on its surfaces. Note that the supercritical fluid of gas 220 evaporates from the mixture 230 when output from the vapor shape control devices 250, 252, 254, and 256 since the supercritical fluid of gas 220 is no longer being compressed or heated. Accordingly, the supercritical fluid of gas 220 can revert back to being gas 206.

It is pointed out that each of the vapor shape control devices (or nozzles) 250, 252, 254, and 256 can be implemented in a wide variety of ways. For example, each of the vapor shape control devices (or nozzles) 250, 252, 254, and 256 can be implemented with, but is not limited to, a funnel or conical shaped device (as shown), any type of aerosol nozzle, and any type of spray nozzle. In one embodiment, the vapor shape control devices 250, 252, 254, and 256 can each be implemented in a different manner. Moreover, in an embodiment, all of the vapor shape control devices 250, 252, 254, and 256 can be implemented in a similar manner.

Within FIG. 3, each of the capillary valves 208 and 232 can be implemented in a wide variety of ways. For example in one embodiment, each of the capillary valves 208 and 232 can be implemented with, but is not limited to, a pulsed solenoid valve that pulses on and off. It is pointed out that in an embodiment, the deposition of the one or more lubricants 224 onto the one or more surfaces of the thin film magnetic media or disk 240 via the lubricant aerosols 239′, 239″, 241′, and 241″ can be controlled by the capillary valve 232 instead of by the amount of time the magnetic media 240 is in and out of the deposition system. Therefore, the capillary valve 232 of the lubricant deposition system 200′ can be utilized to control the lubricant deposition as opposed to strictly time. The capillary valves 208 and 232 can each be coupled to a controller (or computing device) 214 which can independently control the operation of each of them. In an embodiment, the controller 214 can separately transmit an electrical signal (e.g., 3 volts signal) to each of the capillary valves 208 and 232 which causes each to open or close.

In one embodiment, the functionality and/or operations of the controller 214 can be controlled or managed by software, by firmware, by hardware or by any combination thereof, but is not limited to such. Furthermore in an embodiment, the controller 214 can be part of a user interface for the lubricant deposition system 200′.

Within FIG. 3, the lubricant deposition system 200′ can be modified in a wide variety of ways. For example in an embodiment, the lubricant deposition system 200′ can be changed such that multiple compressed gases (e.g., 220) can be pumped into the lubricant reservoir 226. In one embodiment, the lubricant deposition system 200′ can be modified so that the vapor shape control devices (or nozzles) 250, 252, 254, and 256 can each be coupled to a separate lubricant reservoir similar to the lubricant reservoir 226.

The lubricant deposition system 200′ can include, but is not limited to, the pump 202, the gas reservoir 207, the compressor 212, the controller 214, the voltage supply 218, the heater 228, the lubricant vessel 226, the valves 208 and 232, the capillaries 204, 210, 216, 234, 234′, 234″, and 246, the vapor shape control devices (or nozzles) 250, 252, 254, and 256, and the deposition enclosure 242. Specifically in one embodiment, an output of the pump 202 can be coupled to an input of the gas reservoir 207 via the capillary 204. An output of the gas reservoir 207 can be coupled to an input of the compressor 212 via the capillary 210 and the capillary valve 208. An output of the compressor 212 can be coupled to an input of the lubricant reservoir 226 via the capillary 216. An output of the lubricant reservoir 226 can be coupled to the vapor shape control devices (or nozzles) 250, 252, 254, and 256 via the capillaries 234, 234′, and 234″ and the capillary valve 232. An output of the deposition enclosure 242 can be coupled to an input of the pump 202 via the capillary 246. The controller 214 can be coupled to control the pump 202, the capillary valves 208 and 232, the compressor 212, and the voltage supply 218 which controls the heater 228.

It is noted that the lubricant deposition system 200′ may not include all of the elements illustrated by FIG. 3. Additionally, the lubricant deposition system 200′ can be implemented to include one or more elements not illustrated by FIG. 3. It is pointed out that the lubricant deposition system 200′ can be utilized or implemented in any manner similar to that described herein, but is not limited to such.

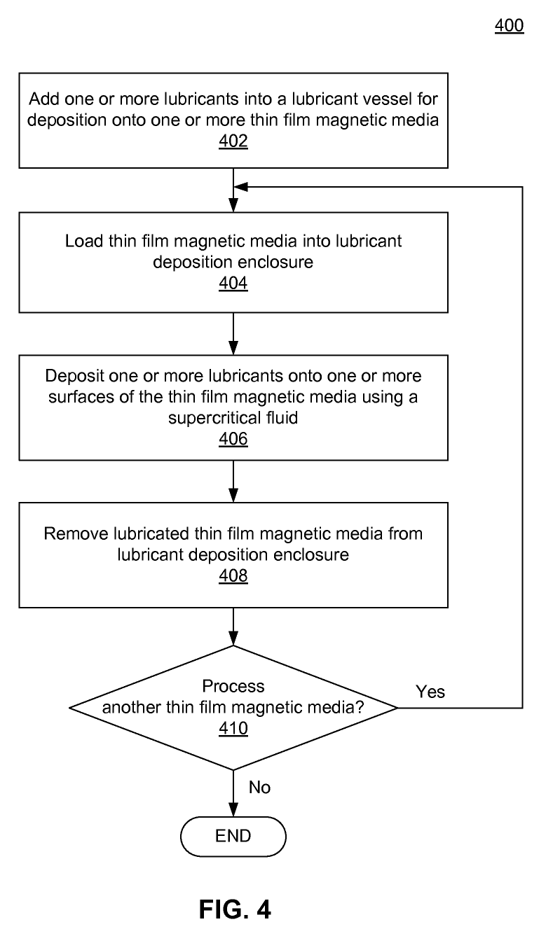

FIG. 4 is a flow diagram of a method 400 in accordance with various embodiments of the invention for using a deposition process to deposit lubricant onto thin film magnetic media. Although specific operations are disclosed in flow diagram 400, such operations are examples. Method 400 may not include all of the operations illustrated by FIG. 4. Also, method 400 may include various other operations and/or variations of the operations shown by FIG. 4. Likewise, the sequence of the operations of flow diagram 400 can be modified. It is appreciated that not all of the operations in flow diagram 400 may be performed. In various embodiments, one or more of the operations of method 400 can be controlled or managed by software, by firmware, by hardware or by any combination thereof, but is not limited to such. Method 400 can include processes of embodiments of the invention which can be controlled or managed by a processor(s) and electrical components under the control of computer or computing device readable and executable instructions (or code). The computer or computing device readable and executable instructions (or code) may reside, for example, in data storage features such as computer or computing device usable volatile memory, computer or computing device usable non-volatile memory, and/or computer or computing device usable mass data storage. However, the computer or computing device readable and executable instructions (or code) may reside in any type of computer or computing device readable medium.

Specifically, method 400 can include adding one or more lubricants into a lubricant vessel for deposition onto one or more thin film magnetic disks. In addition, a thin film magnetic media (or disk) can be loaded into a lubricant deposition enclosure. A supercritical fluid can be utilized to deposit the one or more lubricants onto the one or more surfaces or sides of the thin film magnetic media. The lubricated thin film magnetic media can be removed from the lubricant deposition enclosure. Additionally, a determination can be made as to whether there is another thin film magnetic media to process. If so, process 400 can return to the operation involving loading a thin film magnetic media into the lubricant deposition enclosure. However, if it is determined that there is not another thin film magnetic media to be processed, process 400 can be ended. In this manner, a supercritical fluid can be utilized to deposit one or more lubricants onto thin film magnetic media in accordance with various embodiments of the invention.

At operation 402 of FIG. 4, one or more lubricants (e.g., 224) can be put into or added to a lubricant vessel (e.g., 226) for deposition onto one or more thin film magnetic disks (e.g., 240). It is pointed out that operation 402 can be implemented in a wide variety of ways. For example, operation 402 can be implemented in any manner similar to that described herein, but is not limited to such.

At operation 404, a thin film magnetic media or disk (e.g., 240) can be loaded or inserted into a lubricant deposition enclosure (e.g., 242). It is noted that operation 404 can be implemented in a wide variety of ways. For example, operation 404 can be implemented in any manner similar to that described herein, but is not limited to such.

At operation 406 of FIG. 4, a supercritical fluid can be utilized to deposit the one or more lubricants (e.g., 224) onto the one or more surfaces or sides of the thin film magnetic media. Note that operation 406 can be implemented in a wide variety of ways. For example, operation 406 can be implemented in any manner similar to that described herein, but is not limited to such.

At operation 408, the lubricated thin film magnetic media can be removed from the lubricant deposition enclosure. It is pointed out that operation 408 can be implemented in a wide variety of ways. For example, operation 408 can be implemented in any manner similar to that described herein, but is not limited to such.

At operation 410 of FIG. 4, a determination can be made as to whether there is another thin film magnetic media or disk to process. If so, process 400 can proceed to operation 404. However, if it is determined at operation 410 that there is not another thin film magnetic media or disk to be processed, process 400 can be ended. It is noted that operation 410 can be implemented in a wide variety of ways. For example, operation 410 can be implemented in any manner similar to that described herein, but is not limited to such. In this fashion, a supercritical fluid can be utilized to deposit one or more lubricants onto thin film magnetic media in accordance with various embodiments of the invention.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

1. A method comprising:
pumping a gas into a reservoir that includes a lubricant;
changing said gas into a supercritical fluid that extracts lubricant molecules from said lubricant resulting in a mixture of said supercritical fluid and said lubricant molecules; and
utilizing said mixture to deposit a lubricant molecule onto a magnetic media.

2. The method of claim 1, wherein said gas comprises carbon dioxide.

3. The method of claim 1, wherein said lubricant comprises a perfluoropolyether.

4. The method of claim 1, wherein said magnetic media comprises a magnetic disk comprising a tribological coating.

5. The method of claim 1, wherein said pumping comprises compressing said gas.

6. The method of claim 1, wherein said utilizing further comprises outputting said mixture from said reservoir via a nozzle.

7. The method of claim 1, where said changing comprises heating said reservoir.

8. A system comprising:
a nozzle;
a reservoir coupled to said nozzle and for holding a lubricant;
a compressor for pumping a gas into said reservoir and for controlling an internal pressure of said reservoir;
a heater for changing the temperature of said reservoir;
wherein said compressor and said heater for converting said gas into a supercritical fluid within said reservoir that extracts lubricant molecules from said lubricant resulting in a mixture of said supercritical fluid and said lubricant molecules;
wherein said nozzle for outputting said mixture towards a magnetic media.

9. The system of claims 8, wherein said gas comprises carbon dioxide.

10. The system of claims 8, wherein said lubricant comprises a perfluoropolyether.

11. The system of claims 8, wherein said magnetic media comprises a magnetic disk comprising a tribological coating.

12. The system of claims 8, further comprising a controller electrically coupled to and for controlling said compressor and said heater.

13. The system of claims 8, further comprising an enclosure for receiving said magnetic media.

14. The system of claims 13, wherein said nozzle is internal to said enclosure.

15. The system of claim 8, wherein said nozzle is an aerosol nozzle.

16. A method comprising:
pumping a gas into a reservoir that includes a plurality of lubricants;
altering said gas into a supercritical fluid that extracts lubricant molecules from said plurality of lubricants resulting in a mixture of said supercritical fluid and said lubricant molecules; and
outputting said mixture from said reservoir to deposit lubricants onto a magnetic disk.

17. The method of claim 16, wherein said gas comprises methane.

18. The method of claim 16, wherein said plurality of lubricants comprise a tetrahydroxy perfluoropolyether.

19. The method of claim 16, wherein said plurality of lubricants comprise different types of perfluoropolyether.

20. The method of claim 16, wherein said outputting further comprises outputting said mixture from said reservoir via a vapor shape control device.
